(19) United States
(12) Patent Application Publication
(10) Pub. No.: US 2012/0300573 A1
(43) Pub. Date: Nov. 29, 2012

(54) POINT-OF-USE PROCESS CONTROL BLENDER SYSTEMS AND CORRESPONDING METHODS

(75) Inventor: Karl J. URQUHART, Chanhassen, MN (US)

(73) Assignee: Air Liquide Electronics U.S. LP, Dallas, TX (US)

(21) Appl. No.: 13/571,510

(22) Filed: Aug. 10, 2012

Related U.S. Application Data
(62) Division of application No. 11/533,826, filed on Sep. 21, 2006, now abandoned.
Application No. 11/533,826 is a continuation-in-part of application No. 11/107,494, filed on Apr. 15, 2005, now Pat. No. 7,344,297.
Application No. 11/107,494 is a continuation-in-part of application No. 10/939,570, filed on Sep. 13, 2004, now abandoned.
Application No. 10/939,570 is a division of application No. 09/468,411, filed on Dec. 20, 1999, now Pat. No. 6,799,883.
Application No. 09/468,411 is a continuation-in-part of application No. 09/051,304, filed on Apr. 16, 1998, now Pat. No. 6,050,283.
(60) Provisional application No. 60/720,597, filed on Sep. 26, 2005.

(51) Int. Cl. B01F 15/04

(52) U.S. Cl. 366/151.1; 366/160.1; 366/160.5

(57) ABSTRACT

A blender system is provided that maintains a chemical solution bath at desired concentrations. The blender system includes a blender unit configured to receive and blend at least two chemical compounds and deliver a solution including a mixture of compounds at selected concentrations to a tank that retains a selected volume of a chemical solution bath. The blender system further includes a controller configured to maintain at least one compound within a selected concentration range in the chemical solution bath. The controller controls at least one of operation of the blender unit to maintain the concentration of the compound within a selected concentration range within the solution delivered to the tank, and a change in flow rate of solution into and out of the tank when a concentration of the compound within the chemical solution bath falls outside of a target range.

### CROSS-REFERENCE TO RELATED APPLICATIONS

This is a divisional application of U.S. patent application Ser. No. 11/533,826, filed Sep. 21, 2006, which claims priority from U.S. Provisional Patent Application Ser. No. 60/720,597, entitled “Point of Use Process Control Blender,” and filed Sep. 26, 2005 and which is a continuation-in-part of U.S. patent application Ser. No. 11/107,494, filed Apr. 15, 2005, which is a continuation-in-part of U.S. patent application Ser. No. 10/939,570, filed Sep. 13, 2004, which is a divisional application of U.S. patent application Ser. No. 09/468,411, filed Dec. 20, 1999 (now U.S. Pat. No. 6,799,883), which is a continuation-in-part of U.S. patent application Ser. No. 09/051,304, filed Apr. 16, 1998 (now U.S. Pat. No. 6,050,283). The disclosures of the above-identified patent applications are incorporated herein by reference in their entireties.

### BACKGROUND

1. Field

The disclosure pertains to point-of-use blenders that control concentrations of chemical solutions for delivery to chemical delivery systems such as semiconductor fabrication tools.

2. Related Art

In the semiconductor manufacturing industry, such as wafer cleaning and etching processes, chemical solutions are typically used for wafer cleaning and etching processes. Accurate mixing of reagents at desired ratios is particularly important because variations in concentration of the chemicals introduce uncertainty in etch rates and, hence, are a source of process variation.

Examples of compounds that are used in chemical solutions for the semiconductor manufacturing industry include, without limitation, hydrofluoric acid (HF), ammonium fluoride (NH₄F), hydrochloric acid (HCl), sulfuric acid (H₂SO₄), acetic acid (CH₃OOH), ammonia or ammonium hydroxide (NH₄OH), potassium hydroxide (KOH), ethylene diamine (EDA), hydrogen peroxide (H₂O₂), nitric acid (HNO₃), and any one or more combinations thereof. For example, standard cleaning solutions of the SC-1 type include mixtures of ammonium hydroxide and hydrogen peroxide in de-ionized water (DIW). Standard cleaning solutions of the SC-2 type include an aqueous mixture of hydrogen peroxide with hydrochloric acid. In addition, surfactants and/or other cleaning agents can also be added to such cleaning solution mixtures to enhance the performance of the cleaning solution for a particular operation.

The cleaning solution mixtures can be prepared off-site and then shipped to an end point location or a point-of-use for a cleaning process (e.g., a tool such as a cleaning bath tank or tank for a semiconductor wafer cleaning process). Alternatively, and more desirably, the cleaning solution mixtures are prepared at the point-of-use with a suitable mixer or blender system prior to delivery to the cleaning process.

One problem associated with chemical solutions containing a mixture of compounds is that it can become difficult to precisely control the concentrations of one or more compounds in the final solutions due to decomposition reactions that occur during use of the chemical solutions in a tool. For example, in copper slurry applications utilizing unstable compounds for semiconductor process, the addition of compounds such as ammonium peroxysulfate (APS) in a chemical composition can result in the decomposition of H₂O₂ and/or other components in the final blend, which will result in an undesirable change in the final concentrations of components in the chemical solution.

For example, in conventional systems utilizing SC-1 cleaning solutions, H₂O₂ and/or NH₄OH are typically added directly into the tool (e.g., a cleaning bath) as necessary to account for such decompositions in the cleaning solution. However, the addition or spiking of one or more of these compounds into the cleaning solution can lead to the dilution of other compounds in the cleaning solution and thus does not ensure a precise concentration of the compounds in the final cleaning solution throughout the process.

It is therefore desirable to provide an effective system for delivering chemical solutions with two or more compounds mixed together to a process at selected concentrations while precisely maintaining the concentrations of the compounds in the final solutions within acceptable levels or ranges during the process cycle.

### SUMMARY

Point-of-use process control blender systems and corresponding methods are described herein that effectively deliver and maintain chemical solutions at selected concentrations for use in processes, such as semiconductor wafer cleaning processes.

A blender system for maintaining a chemical solution bath at desired concentrations comprises a blender unit configured to receive and blend at least two chemical compounds and deliver a solution comprising a mixture of compounds at selected concentrations to a tank that retains a selected volume of at least one chemical solution bath. The blender system further comprises a controller configured to maintain at least one compound within a selected concentration range in the chemical solution bath. The controller controls at least one of operation of the blender unit to maintain the concentration of the at least one compound within a selected concentration range within the solution delivered to the tank, and a change in flow rate of solution into and out of the tank when a concentration of the at least one compound within the chemical solution bath falls outside of a target range.

In another embodiment, a method of providing a chemical solution to a tank comprises providing at least two compounds to a blender unit to form a mixed solution of the at least two compounds at selected concentrations, and providing the mixed solution from the blender unit to a tank to form a chemical solution bath within the tank, where the chemical solution bath has a selected volume. A concentration of at least one compound is maintained in the chemical solution bath within a selected concentration range by at least one of: controlling the blender unit to maintain the concentration of the at least one compound within a selected concentration range within the solution delivered to the tank; and changing a flow rate of solution into and out of the tank when a concentration of the at least one compound within the chemical solution bath falls outside of a target range.

The systems and corresponding methods are particularly useful for maintaining concentrations of chemical solutions for semiconductor applications (e.g., for maintaining SC-1 cleaning solutions including ammonium hydroxide and hydrogen peroxide) within acceptable concentration ranges despite decomposition and/or other reactions of compounds within the chemical solutions that may occur during processing operations within one or more tools. In addition, the point-of-use blender system is designed to be implemented immediately or substantially proximate any one or more process tools or, alternatively, integrated as a component or part of one or more process tools. Further, the blender system can be configured to supply chemical solutions at precise concentrations to a plurality of process tools.

The above and still further features and advantages will become apparent upon consideration of the following detailed description of specific embodiments thereof, particularly when taken in conjunction with the accompanying drawings wherein like reference numerals in the figures are utilized to designate like components.

### BRIEF DESCRIPTION OF THE DRAWINGS

FIG. 1 is a schematic diagram of an exemplary embodiment of a semiconductor wafer cleaning system including a cleaning bath connected with a point-of-use process control blender system that prepares and delivers a cleaning solution to the cleaning bath during a cleaning process.

FIG. 2 is a schematic diagram of an exemplary embodiment of the process control blender system of FIG. 1.

### DETAILED DESCRIPTION

Point-of-use process control blender systems are described herein which include at least one blender unit to receive and blend at least two chemical compounds together for delivery to one or more vessels or tanks including chemical baths that facilitate processing (e.g., cleaning) of semiconductor wafers or other components. The chemical solution is maintained at a selected volume and temperature within the tank or tanks, and the blender system can be configured to continuously deliver chemical solution to one or more tanks or, alternatively, deliver chemical solution to the one or more tanks only as necessary (as described below), so as to maintain concentrations of compounds within the tank(s) within desirable ranges.

The tank can be part of a process tool, such that the blender system provides chemical solution directly to a process tool that includes a selected volume of a chemical bath. The process tool can be any conventional or other suitable tool that processes a semiconductor wafer or other component (e.g., via an etching process, a cleaning process, etc.). Alternatively, the blender system can provide chemical solution to one or more holding or storage tanks, where the storage tank or tanks then provide the chemical solution to one or more process tools.

In a preferred embodiment, a point-of-use process control blender system is provided that is configured to increase the flow rate of chemical solution to one or more tanks when the concentration of one or more compounds within the solution falls outside of a selected target range, so as to rapidly displace undesirable chemical solution(s) from the tank(s) while supplying fresh chemical solution to the tank(s) at the desired compound concentrations.

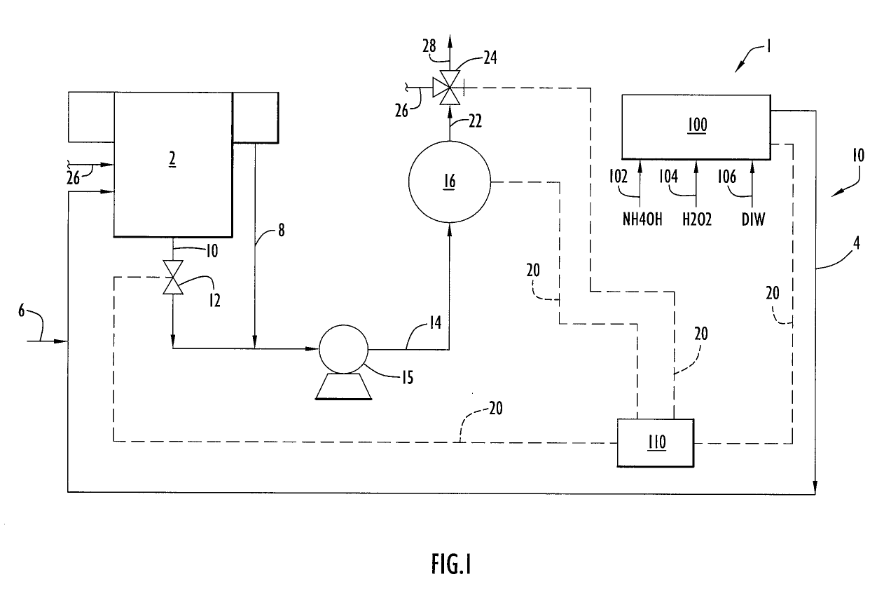

An exemplary embodiment of a system 1 is depicted in FIG. 1 and includes a point-of-use process control blender system 10 combined with a process tool in the form of a cleaning tank 2 for cleaning of semiconductor wafers or other components. Alternatively, and as noted above, tank 2 can be a storage tank that provides a chemical at the desired concentrations to one or more semiconductor process tools.

An inlet of cleaning tank 2 is connected with a blender unit 100 via a flow line 4. In this embodiment, the cleaning solution formed in the blender unit 100 and provided to cleaning tank 2 is an SC-1 cleaning solution, with ammonium hydroxide (NH₄OH) being provided to the blender unit via a supply line 102, hydrogen peroxide (H₂O₂) being provided to the blender unit via a supply line 104, and de-ionized water (DIW) being provided to the blender unit via a supply line 106. However, it is noted that the blender system can be configured to provide a mixture of any selected number (i.e., two or more) of chemical compounds at selected concentrations to any type of tool, where the mixtures can include chemical compounds such as hydrofluoric acid (HF), ammonium fluoride (NH₄F), hydrochloric acid (HCl), sulfuric acid (H₂SO₄), acetic acid (CH₃OOH), ammonium hydroxide (NH₄OH), potassium hydroxide (KOH), ethylene diamine (EDA), hydrogen peroxide (H₂O₂), and nitric acid (HNO₃).

In addition, any suitable surfactants and/or other chemical additives (e.g., ammonium peroxysulfate or APS) can be combined with the cleaning solutions to enhance the cleaning effect for a particular application. A flow line 6 is optionally connected with flow line 4 between the blender unit 100 and the inlet to tank 2 to facilitate the addition of such additives to the cleaning solution for use in the cleaning bath.

Tank 2 is suitably dimensioned and configured to retain a selected volume of cleaning solution within the tank (e.g., a sufficient volume to form the cleaning bath for cleaning operations). As noted above, the cleaning solution can be continuously provided from blender unit 100 to tank 2 at one or more selected flow rates. Alternatively, cleaning solution can be provided from the blender unit to the tank only at selected time periods (e.g., at initial filling of the tank, and when one or more components in the cleaning solution within the tank falls outside of a selected or target concentration range). Tank 2 is further configured with an overflow section and outlet that permits cleaning solution to exit the tank via overflow line 8 while maintaining the selected cleaning solution volume within the tank as cleaning solution is continuously fed and/or recirculated to the tank in the manner described below.

The tank is also provided with a drain outlet connected with a drain line 10, where the drain line 10 includes a valve 12 that is selectively controlled to facilitate draining and removal of cleaning solution at a faster rate from the tank during selected periods as described below. Drain valve 12 is preferably an electronic valve that is automatically controlled by a controller 110 (described in further detail below). The overflow and drain lines 8 and 10 are connected to a flow line 14 including a pump 15 disposed therein to facilitate delivery of the cleaning solution removed from tank 2 to a recirculation line 26 and/or a collection site or further processing site as described below.

A concentration monitor unit 16 is disposed in flow line 14 at a location downstream from pump 15. The concentration monitor unit 16 includes at least one sensor configured to measure the concentration of one or more chemical compounds in the cleaning solution (e.g., H₂O₂ and/or NH₄OH) as the cleaning solution flows through line 14. The sensor or sensors of concentration monitor unit 16 can be of any suitable types to facilitate accurate concentration measurements of one or more chemical compounds of interest in the cleaning solution. Preferably, the concentration sensors used in the system are electrode-less conductivity probes and/or Refraction Index (RI) detectors including, without limitation, AC toroidal coil sensors such as the types commercially available under the model 3700 series from GLI International, Inc. (Colorado), RI detectors such as the types commercially available under the model CR-288 from Swagelok Company (Ohio), and acoustic signature sensors such as the types commercially available from Mesa Laboratories, Inc. (Colorado).

A flow line 22 connects an outlet of concentration monitor unit 16 with an inlet of a three-way valve 24. The three-way valve is preferably an electronic valve that is automatically controlled by controller 110 in the manner described below based upon concentration measurements provided by unit 16. A recirculation line 26 connects with an outlet of valve 24 and extends to an inlet of tank 2 to facilitate recirculation of solution from the overflow line 8 back to the tank during normal system operation (as described below). A drain line 28 extends from another outlet of valve 24 to facilitate removal of solution from tank 2 (via line 8 and/or line 14) when one or more component concentrations within the solution are outside of the target ranges.

Recirculation flow line 26 can include any suitable number and types of temperature, pressure and/or flow rate sensors and also one or more suitable heat exchangers to facilitate heating, temperature and flow rate control of the solution as it recirculates back to the tank 2. The recirculation line is useful for controlling the solution bath temperature within the tank during system operation. In addition, any suitable number of filters and/or pumps (e.g., in addition to pump 15) can be provided along flow line 26 to facilitate filtering and flow rate control of the solution being recirculated back to tank 2.

The process control blender system 10 includes a controller 110 that automatically controls components of the blender unit as well as drain valve 12 based upon concentration measurements obtained by concentration monitor unit 16. As described below, the controller controls the flow rate of cleaning solution from blender unit 100 and draining or withdrawal of cleaning solution from tank 2 depending upon the concentration of one or more compounds in the cleaning solution exiting tank 2 as measured by concentration monitor unit 16.

Controller 110 is in communication (as indicated by dashed lines 20 in FIG. 1) with drain valve 12, concentration monitor unit 16, and valve 24, as well as certain components of blender unit 100 via any suitable electrical wiring or wireless communication link to facilitate control of the blender unit and drain valve based upon measured data received from the concentration monitor unit. The controller can include a processor that is programmable to implement any one or more suitable types of process control, such as proportional-integral-derivative (PID) feedback control. An exemplary controller that is suitable for use in the process control blender system is a PLC Simatic S7-300 system commercially available from Siemens Corporation (Georgia).

As noted above, the blender unit 100 receives independently fed streams of ammonium hydroxide, hydrogen peroxide and de-ionized water (DIW), which are mixed with each other at suitable concentrations and flow rates so as to obtain an SC-1 cleaning solution having a desired concentration of these compounds. The controller 110 controls the flow of each of these compounds within blender unit 100 to achieve the desired final concentration and further controls the flow rate of SC-1 cleaning solution to form the cleaning bath in tank 2.

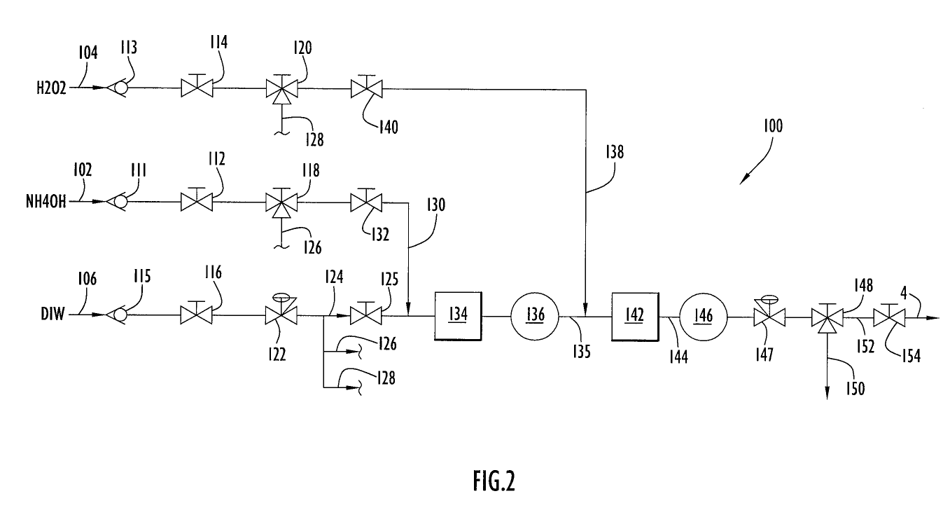

An exemplary embodiment of the blender unit is depicted in FIG. 2. In particular, each of the supply lines 102, 104 and 106 for supplying NH₄OH, H₂O₂ and DIW to blender unit 100 includes a check valve 111, 113, 115 and an electronic valve 112, 114, 116 disposed downstream from the check valve. The electronic valve for each supply line is in communication with controller 110 (e.g., via electronic wiring or wireless link) to facilitate automatic control of the electronic valves by the controller during system operation. Each of the NH₄OH and H₂O₂ supply lines 102 and 104 respectively connects with an electronic three-way valve 118, 120 that is in communication with controller 110 (via electronic wiring or a wireless link) and is disposed downstream from the first electronic valve 112, 114.

The DIW supply line 106 includes a pressure regulator 122 disposed downstream from electronic valve 116 to control the pressure and flow of DIW into system 100, and line 106 further branches into three flow lines downstream from regulator 122. A first branched line 124 extending from main line 106 includes a flow control valve 125 disposed along the branched line and which is optionally controlled by controller 110, and line 124 further connects with a first static mixer 134. A second branched line 126 extends from main line 106 to an inlet of the three-way valve 118 that is also connected with NH₄OH flow line 102. In addition, a third branched line 128 extends from main line 106 to an inlet of the three-way valve 120 which is also connected with H₂O₂ flow line 104. Thus, the three-way valves for each of the NH₄OH and H₂O₂ flow lines facilitate the addition of DIW to each of these flows to selectively adjust the concentration of ammonium hydroxide and hydrogen peroxide in distilled water during system operation and prior to mixing with each other in the static mixers of the blender unit.

An NH₄OH flow line 130 is connected between an outlet of the three-way valve 118 for the ammonium hydroxide supply line and the first branch line 124 of the de-ionized water supply line at a location between valve 125 and static mixer 134. Optionally, flow line 130 can include a flow control valve 132 that can be automatically controlled by controller 110 to enhance flow control of ammonium hydroxide fed to the first static mixer. The ammonium hydroxide and de-ionized water fed to the first static mixer 134 are combined in the mixer to obtain a mixed and generally uniform solution. A flow line 135 connects with an outlet of the first static mixture and extends to and connects with a second static mixer 142. Disposed along flow line 135 is any one or more suitable concentration sensors 136 (e.g., one or more electrode-less sensors or RI detectors of any of the types described above) that determines the concentration of ammonium hydroxide in the solution. Concentration sensor 136 is in communication with controller 110 so as to provide the measured concentration of ammonium hydroxide in the solution emerging from the first static mixer. This in turn facilitates control of the concentration of ammonium hydroxide in this solution prior to delivery to the second static mixer 142 by selective and automatic manipulation of any of the valves in one or both of the NH₄OH and DIW supply lines by the controller.

A H₂O₂ flow line 138 connects with an outlet of the three-way valve 120 that is connected with the H₂O₂ supply line. Flow line 138 extends from three-way valve 120 to connect with flow line 135 at a location that is between concentration sensor(s) 136 and second static mixer 142. Optionally, flow line 138 can include a flow control valve 140 that can be automatically controlled by controller 110 to enhance flow control of hydrogen peroxide fed to the second static mixer. The second static mixer 142 mixes the DIW diluted NH₄OH solution received from the first static mixer 134 with the H₂O₂ solution flowing from the H₂O₂ feed line to form a mixed and generally uniform SC-1 cleaning solution of ammonium hydroxide, hydrogen peroxide and de-ionized water. A flow line 144 receives the mixed cleaning solution from the second static mixture and connects with an inlet of an electronic three-way valve 148.

Disposed along flow line 144, at a location upstream from valve 148, is at least one suitable concentration sensor 146 (e.g., one or more electrode-less sensors or RI detectors of any of the types described above) that determines the concentration at least one of hydrogen peroxide and ammonium hydroxide in the cleaning solution. Concentration sensor(s) 146 is also in communication with controller 110 to provide measured concentration information to the controller, which in turn facilitates control of the concentration of ammonium hydroxide and/or hydrogen peroxide in the cleaning solution by selective and automatic manipulation of any of the valves in one or more of the NH₄OH, H₂O₂ and DIW feed lines by the controller. Optionally, a pressure regulator 147 can be disposed along flow line 144 between sensor 146 and valve 148 so as to control the pressure and flow of cleaning solution.

A drain line 150 connects with an outlet of three-way valve 148, while flow line 152 extends from another outlet port of three-way valve 148. The three-way valve is selectively and automatically manipulated by controller 110 to facilitate control of the amount of cleaning solution that emerges from the blender unit for delivery to tank 2 and the amount that is diverted to drain line 150. In addition, an electronic valve 154 is disposed along flow line 152 and is automatically controlled by controller 110 to further control flow of cleaning solution from the blender unit to tank 2. Flow line 152 becomes flow line 4 as shown in FIG. 1 for delivery of SC-1 cleaning solution to tank 2.

The series of electronic valves and concentration sensors disposed within blender unit 100 in combination with controller 110 facilitate precise control of the flow rate of cleaning solution to the tank and also the concentrations of hydrogen peroxide and ammonium peroxide in the cleaning solution at varying flow rates of the cleaning solution during system operation. Further, the concentration monitor unit 16 disposed along the drain line 14 for tank 2 provides an indication to the controller when the concentration of one or both the hydrogen peroxide and ammonium peroxide falls outside of an acceptable range for the cleaning solution.

Based upon concentration measurements provided by concentration monitor unit 16 to controller 110, the controller is preferably programmed to implement a change in flow rate of cleaning solution to the tank and to open drain valve 12 so as to facilitate a rapid displacement of SC-1 cleaning solution in the bath while supplying fresh SC-1 cleaning solution to the tank, thus bringing the cleaning solution bath within compliant or target concentration ranges as quickly as possible. Once cleaning solution has been sufficiently displaced from the tank such that the hydrogen peroxide and/or ammonium hydroxide concentrations fall within acceptable ranges (as measured by concentration monitor unit 16), the controller is programmed to close drain valve 12 and to control the blender unit so as to reduce (or cease) the flow rate while maintaining the desired compound concentrations within the cleaning solution being delivered to the tank 2.

An exemplary embodiment of a method of operating the system described above and depicted in FIGS. 1 and 2 is described below. In this exemplary embodiment, cleaning solution can be continuously provided to the tank or, alternatively, provided only at selected intervals to the tank (e.g., when cleaning solution is to be displaced from the tank). An SC-1 cleaning solution is prepared in blender unit 100 and provided to tank 2 with a concentration of ammonium hydroxide in a range from about 0.01-29% by weight, preferably about 1.0% by weight, and a concentration of hydrogen peroxide in a range from about 0.01-31% by weight, preferably about 5.5% by weight. The cleaning tank 2 is configured to maintain about 30 liters of cleaning solution bath within the tank at a temperature in the range from about 25° C. to about 125° C.

In operation, upon filling the tank 2 with cleaning solution to capacity, the controller 110 controls blender unit 100 to provide cleaning solution to tank 2 via flow line 4 at a first flow rate from about 0-10 liters per minute (LPM), where the blender can provide solution continuously or, alternatively, at selected times during system operation. When the solution is provided continuously, an exemplary first flow rate is about 0.001 LPM to about 0.25 LPM, preferably about 0.2 LPM. Ammonium hydroxide supply line 102 provides a feed supply of about 29-30% by volume NH₄OH to the blender unit, while hydrogen peroxide supply line 104 provides a feed supply of about 30% by volume H₂O₂ to the blender unit. At a flow rate of about 0.2 LPM, the flow rates of the supply lines of the blender unit can be set as follows to ensure a cleaning solution is provided having the desired concentrations of ammonium hydroxide and hydrogen peroxide: about 0.163 LPM of DIW, about 0.006 LPM of NH₄OH, and about 0.031 LPM of H₂O₂.

Additives (e.g., APS) can optionally be added to the cleaning solution via supply line 6. In this stage of operation, a continuous flow of fresh SC-1 cleaning solution can be provided from the blender unit 100 to tank 2 at the first flow rate, while cleaning solution from the cleaning bath is also exiting tank 2 via overflow line 8 at generally the same flow rate (i.e., about 0.2 LPM). Thus, the volume of the cleaning solution bath is maintained relatively constant due to the same or generally similar flow rates of cleaning solution to and from the tank. The overflow cleaning solution flows into drain line 14 and through concentration monitor unit 16, where concentration measurements of one or more compounds (e.g., H₂O₂ and/or NH₄OH) within the cleaning solution are determined continuously or at selected time intervals, and such concentration measurements are provided to controller 110.

Cleaning solution can optionally be circulated by adjusting valve 24 such that cleaning solution flowing from tank 2 flows through recirculation line 26 and back into the tank at a selected flow rate (e.g., about 20 LPM). In such operations, blender unit 100 can be controlled such that no cleaning solution is delivered from the blender unit to the tank unless the concentrations of one or more compounds in the cleaning solution are outside of selected target ranges. Alternatively, cleaning solution can be provided by the blender unit at a selected flow rate (e.g., about 0.20 LPM) in combination with the recirculation of cleaning solution through line 26. In this alternative operating embodiment, three-way valve 24 can be adjusted (e.g., automatically by controller 110) to facilitate removal of cleaning solution into line 28 at about the same rate as cleaning solution being provided to the tank by the blender unit, while cleaning solution still flows through recirculation line 26. In a further alternative, valve 24 can be closed to prevent any recirculation of fluid through line 26 while cleaning solution is continuously provided to tank 2 by blender unit 100 (e.g., at about 0.20 LPM). In this application, solution exits the tank via line 8 at about the same or similar flow rate as the flow rate of fluid into the tank from the blender unit.

For applications in which cleaning solution is continuously provided to the tank, controller 110 maintains the flow rate of cleaning solution from blender unit 100 to tank 2 at the first flow rate, and the concentrations of hydrogen peroxide and ammonium hydroxide within the selected concentration ranges, so long as the measured concentrations provided by the concentration monitor unit 16 are within acceptable ranges. For applications in which cleaning solution is not continuously provided from the blender unit to the tank, controller 110 maintains this state of operation (i.e., no cleaning solution from blender unit to tank) until a concentration of hydrogen peroxide and/or ammonium hydroxide are outside of the selected concentration ranges.

When the concentration of at least one of hydrogen peroxide and ammonium hydroxide, as measured by concentration monitor unit 16, deviates outside of the acceptable range (e.g., the measured concentration of NH₄OH deviates from the range of about 1% relative to a target concentration, and/or the measured concentration of H₂O₂ deviates from the range of about 1% relative to a target concentration), the controller manipulates and controls any one or more of the valves in blender unit 100 as described above to initiate or increase the flow rate of cleaning solution from the blender unit to tank 2 (while maintaining the concentrations of NH₄OH and H₂O₂ in the cleaning solution within the selected ranges) to a second flow rate.

The second flow rate can be in a range from about 0.001 LPM to about 20 LPM. For continuous cleaning solution operations, an exemplary second flow rate is about 2.5 LPM. The controller further opens drain valve 12 in tank 2 to facilitate a flow of cleaning solution from the tank at about the same flow rate. At the flow rate of about 2.5 LPM, the flow rates of the supply lines of the blender unit can be set as follows to ensure a cleaning solution is provided having the desired concentrations of ammonium hydroxide and hydrogen peroxide: about 2.04 LPM of DIW, about 0.070 LPM of NH₄OH, and about 0.387 LPM of H₂O₂.

Alternatively, cleaning solution that is being recirculated to the tank at a selected flow rate (e.g., about 20 LPM) is removed from the system by adjusting three-way valve 24 so that cleaning fluid is diverted into line 28 and no longer flows into line 26, and the blender unit adjusts the second flow rate to a selected level (e.g., 20 LPM) so as to compensate for the removal of fluid at the same or similar flow rate. Thus, the volume of cleaning solution bath within tank 2 can be maintained relatively constant during the increase in flow rate of cleaning solution to and from the tank. In addition, the process temperature and circulation flow parameters within the tank can be maintained during the process of replacing a selected volume of the solution within the tank.

The controller maintains delivery of the cleaning solution to tank 2 at the second flow rate until concentration monitor unit 16 provides concentration measurements to the controller that are within the acceptable ranges. When the concentration measurements by concentration monitor unit 16 are within the acceptable ranges, the cleaning solution bath is again compliant with the desired cleaning compound concentrations. The controller then controls blender unit 100 to provide the cleaning solution to tank 2 at the first flow rate (or with no cleaning solution being provided to the tank from the blender unit), and the controller further manipulates drain valve 12 to a closed position so as to facilitate flow of cleaning solution from the tank only via overflow line 8. In applications in which the recirculating line is used, the controller manipulates three-way valve 24 such that cleaning solution flows from line 14 into line 26 and back into tank 2.

Thus, the point-of-use process control blender system described above is capable of effectively and precisely controlling the concentration of at least two compounds in a cleaning solution delivered to a chemical solution tank (e.g., a tool or a solution tank) during an application or process despite potential decomposition and/or other reactions that may modify the chemical solution concentration in the tank. The system is capable of continuously providing fresh chemical solution to the tank at a first flow rate, and rapidly displacing chemical solution from the tank with fresh chemical solution at a second flow rate that is faster than the first flow rate when the chemical solution within the tank is determined to have undesirable or unacceptable concentrations of one or more compounds.

The point-of-use process control blender systems are not limited to the exemplary embodiments described above and depicted in FIGS. 1 and 2. Rather, such systems can be used to provide chemical solutions with mixtures of any two or more compounds such as the types described above to any semiconductor processing tank or other selected tool, while maintaining the concentrations of compounds within the chemical solutions within acceptable ranges during cleaning applications.

In addition, the process control blender system can be implemented for use with any selected number of solution tanks or tanks and/or semiconductor process tools. For example, a controller and blender unit as described above can be implemented to supply chemical solution mixtures with precise concentrations of two or more compounds directly to two or more process tools. Alternatively, the controller and blender unit can be implemented to supply such chemical solutions to one or more holding or storage tanks, where such storage tanks supply chemical solutions to one or more process tools. The process control blender system provides precise control of the concentrations of compounds in the chemical solutions by monitoring the concentration of solution(s) within the tank or tanks, and replacing or replenishing solutions to such tanks when the solution concentrations fall outside of target ranges.

The design and configuration of the process control blender system facilitates placement of the system in substantially close proximity to the one or more chemical solution tanks and/or process tools which are to be provided with chemical solution from the system. In particular, the process control blender system can be situated in or near the fabrication (fab) or clean room or, alternatively, in the sub-fab room but proximate where the solution tank and/or tool is located in the clean room. For example, the process control blender system, including the blender unit and controller, can be situated within about 30 meters, preferably within about 15 meters, and more preferably within about 3 meters or less, of the solution tank or process tool. Further, the process control blender system can be integrated with one or more tools so as to form a single unit including the process blender system and tool(s).

Having described novel point-of-use process control blender systems and corresponding methods for delivering and maintaining chemical solutions at desired concentration levels for processes, it is believed that other modifications, variations and changes will be suggested to those skilled in the art in view of the teachings set forth herein. It is therefore to be understood that all such variations, modifications and changes are believed to fall within the scope as defined by the appended claims.

1. A method of providing a chemical solution to a tank comprising:
providing at least two compounds to a blender unit to form a mixed solution of the at least two compounds at selected concentrations;
providing the mixed solution from the blender unit to a tank to form a chemical solution bath within the tank, wherein the chemical solution bath has a selected volume; and
maintaining a concentration of at least one compound in the chemical solution bath within a selected concentration range by at least one of:
controlling the blender unit to maintain the concentration of the at least one compound within a selected concentration range within the solution delivered to the tank; and
changing a flow rate of solution into and out of the tank when a concentration of the at least one compound within the chemical solution bath falls outside of a target range.

2. The method of claim 1, wherein the blender unit continuously delivers solution to the tank during system operation.

3. The method of claim 2, wherein the blender unit is controlled to increase the flow rate of the solution from the blender unit to the tank and a flow rate of chemical solution bath from the tank is increased to maintain the selected volume of chemical solution bath within the tank when the concentration of the at least one compound within the chemical solution bath falls outside of the target range.

4. The method of claim 3, wherein the flow rate of chemical solution bath from the tank is increased by opening a drain valve connected to the tank.

5. The method of claim 3, further comprising:
measuring a concentration of the at least one compound of the chemical solution bath; and
automatically controlling the blender unit and the flow rate of chemical solution bath from the tank, based upon the measured concentration of the at least one compound of the chemical solution bath, so as to maintain the at least one compound within the chemical solution bath within the selected concentration range.

6. The method of claim 3, wherein the blender unit is controlled to provide solution to the tank including the at least one compound within the selected concentration range in the solution at a first flow rate when the concentration of the at least one compound within the chemical solution bath is within the target range, and the blender unit is controlled to provide solution from the blender unit to the tank including the at least one compound within the selected concentration range in the solution at a second flow rate that is greater than the first flow rate when the concentration of the at least one compound within the chemical solution bath is outside of the target range.

7. The method of claim 6, wherein the providing at least two compounds to the blender unit comprises:
providing hydrogen peroxide to the blender unit; and
providing ammonium hydroxide to the blender unit;
wherein delivery of hydrogen peroxide and ammonium hydroxide to the blender unit and operation of the blender unit are controlled such that the solution is provided to the tank at the first and second flow rates while maintaining hydrogen peroxide within a first concentration range and ammonium hydroxide within a second concentration range within the solution delivered to the tank.

8. The method of claim 7, wherein the first flow rate is no greater than about 10 liters per minute, and the second flow rate is no greater than about 20 liters per minute.

9. The method of claim 7, wherein the blender unit and the flow rates of solution to the tank and chemical solution bath from the tank are controlled such that hydrogen peroxide is maintained within a range of about 1% of a first target concentration within the chemical solution bath and ammonium peroxide is maintained within a range of about 1% of a second target concentration within the chemical solution bath.

10. The method of claim 7, wherein the first target concentration of hydrogen peroxide in the chemical solution bath is about 5.5% by weight of the chemical solution bath and the second target concentration of ammonium hydroxide in the chemical solution bath is about 1% by weight of the chemical solution bath.

11. The method of claim 6, further comprising:
delivering a third compound to the chemical solution bath, wherein the third compound decomposes at least one of the hydrogen peroxide and the ammonium hydroxide.

12. The method of claim 1, wherein the tank includes a semiconductor process tool.

13. The method of claim 12, wherein the blender unit is in substantially close proximity to the process tool.
